(19) United States
(12) Patent Application Publication
(10) Pub. No.: US 2003/0164879 A1
(43) Pub. Date: Sep. 4, 2003

(54) Digital camera, print method, and print system

(75) Inventor: Kiichiro Kitagawa, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/376,281

(22) Filed: Mar. 3, 2003

(30) Foreign Application Priority Data
Mar. 4, 2002 (JP) 2002-057782

(51) Int. Cl. H04N 5/225

(52) U.S. Cl. 348/207.2

(57) ABSTRACT

A digital camera is provided with a print section for making a small-sized mini photo print which is used as an index. Upon taking, the digital camera makes the mini photo print, after writing an image data in a memory card. A file name is printed on the mini photo print with a taken image. The image in the memory card is printed in high quality by a commercial printer. In such a print, a file name of the image to be printed is specified, referring to the mini photo print. The memory cards and the mini photo prints are contained and sorted out in transparent pockets of a print holder.

### BACKGROUND OF THE INVENTION

1. Field of the Invention

The present invention relates to a digital camera, a print method, and a print system for easily specifying identity information about an image to be printed.

2. Description of the Prior Arts

Recently, there is a widespread use of a digital camera with an imaging device, such as a CCD image sensor and so forth, which generates an image data of a taken image to be stored in memory media, such as a memory card. The digital camera provides a liquid crystal display, which is used as a view finder at the time of taking, and used for recording the taken image.

The image data stored in the memory card is printed on the memory media by the user's personal printer or a commercial printer in a laboratory, so that a color print is made.

As for the image data stored in the memory media, file format, folder structure, a file name, and so forth are arranged by DCF (Design rule of Camera File system) standard. For example, regarding the file name of the image data, the frame number is given automatically in order of taking, for example DSCF0001.JPG-DSCF000n.JPG.

In a silver film type photographic camera, the taken image is directly recorded on a negative or positive film. The user can know the frame number for identifying the image by observing the negative or positive film and reading the frame number which corresponds to the image to be printed. On the other hand, in the digital camera, the image data is stored in the memory media in a manner invisible to human eyes. In addition, the content of the image cannot be guessed from the file name thereof. Accordingly, when the file name of the image frame to be printed is specified, it is necessary to display each image read out from the memory media on a monitor of the printer or the liquid display of the digital camera.

In case there are some similar images, the image having the best quality is printed in general. However, since the liquid display of the digital camera is small in size, it is difficult to compare the quality of plural images at the same time. Accordingly, in some cases, there is a difference between the image selected by reproducing on the liquid crystal display and the print of the image. Although the image can be observed in large size by connecting the digital camera with a television or a computer, the connection and setting are complicated and troublesome.

If the user orders the laboratory to print the image, it is necessary to reproduce the image in the memory media and identify the file name beforehand. Such process complicates the print order. According to these problems, the image taken by the digital camera is hardly printed.

### SUMMARY OF THE INVENTION

A main object of the present invention is to provide a digital camera, a print method, a print system in which an image to be printed is easily specified.

Another object of the present invention is to provide a digital camera, a print method, and a print system in which the image taken by the digital camera can be sorted out for easy identification.

In order to achieve the above and other objects, the digital camera in the present invention is provided with a print section which prints an image confirmation print having a taken image and identity information based on an image data and an identity information data read from memory media. As a recording material for the image confirmation print, an instant film unit is preferably used. As the memory media, a memory card, a PC card, a micro drive, and so forth are used. As the identity information, a file name and so forth are used.

In the print method of the present invention, firstly, a subject is taken by a digital camera. An image data of the subject is written in a memory media with an identity information data. Secondly, in accordance with the image data and the identity information data read from the memory media, the image and the identity information are printed on a recording material by a print section of the digital camera, so that an image confirmation print is made. Referring to the image confirmation print, the identity information of the image to be printed is specified. Finally, the image data which corresponds to the designated identity information is read from the memory media, and the image is printed by a printer.

The print system of the present invention includes a digital camera for taking an image and making an image confirmation print, a print holder for containing the image confirmation prints with arranged in a plane, and a printer for printing the image in a memory media. When the image is printed by the printer, the identity information is specified from the image confirmation print.

In the present invention, the identity information is printed with the image to make the image confirmation print. The image confirmation prints and the memory media are contained in the print holder, so that it is useful as an index. When a high quality image print is made, the user specifies the identity information of the image to be printed, referring to the image confirmation print. Accordingly, the image taken by the digital camera is sorted out for easy identification, so that the image to be printed is designated easily.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a schematic view showing a structure of a print system of the present invention;

FIG. 2 is a front perspective view of a digital camera;

FIG. 3 is a rear perspective view of the digital camera;

FIG. 4 is a schematic view of the digital camera;

FIG. 5 is an explanation view showing a mini photo print;

FIG. 6 is a perspective view of a film pack;

FIG. 7 is a perspective view of a print holder;

FIG. 8 is a perspective view of a file for stacking print holders; and

FIG. 9 is an explanation view showing a mini photo print on which a bar code is printed.

### DETAILED DESCRIPTION OF THE PREFERRED EMBODIMENTS

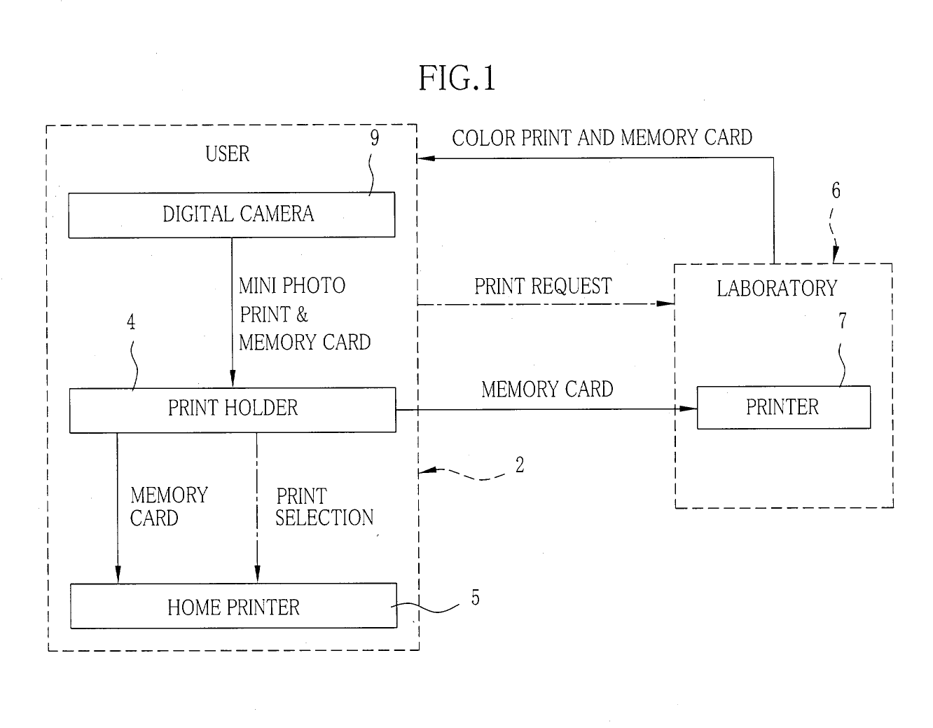

In FIG. 1, a print system is constituted of a digital camera 9 of a user 2, a print holder 4, and a personal printer 5 in a user's home or a commercial printer 7 in a laboratory 6. The digital camera 9 includes a print section for printing a taken image.

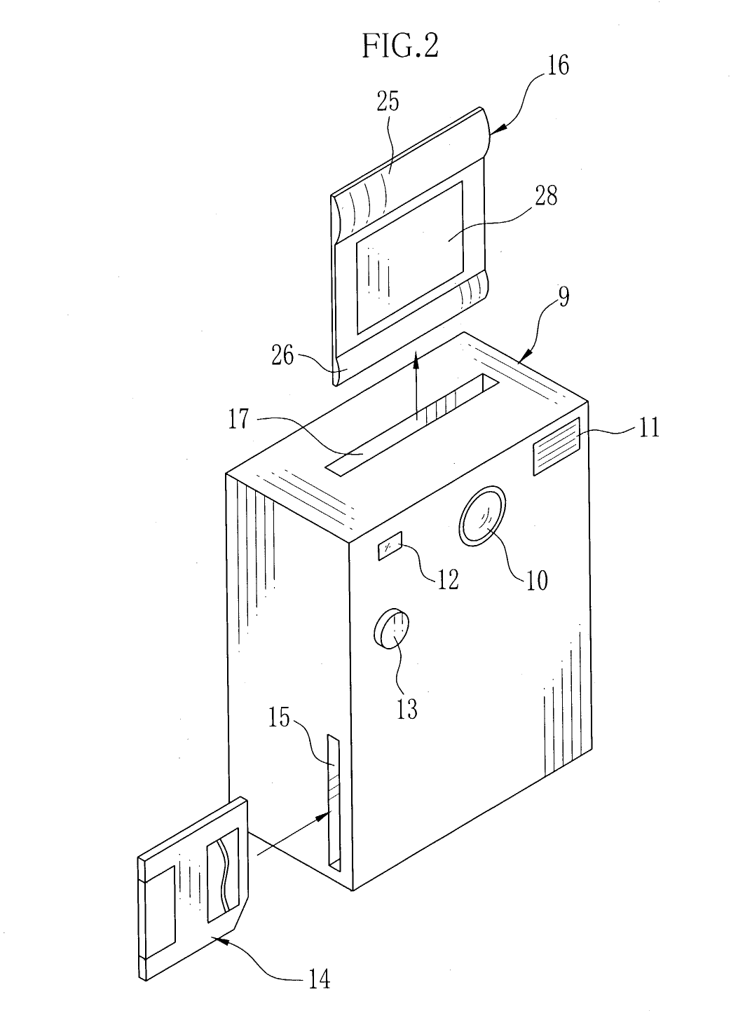

As shown in FIG. 2, on the front of the digital camera 9 are provided a taking lens 10, a flash emitter 11, an objective finder window 12, a shutter button 13, and so forth. The side of the digital camera 9 has a card slot 15 in which a memory card 14 is inserted, and the upper of the digital camera 9 has an outlet 17 through which a mini photo print 16 (a print for confirming the taken image) is discharged. As memory media, a memory stick, a PC card, a micro drive, and so forth may be used as well as the memory card 14.

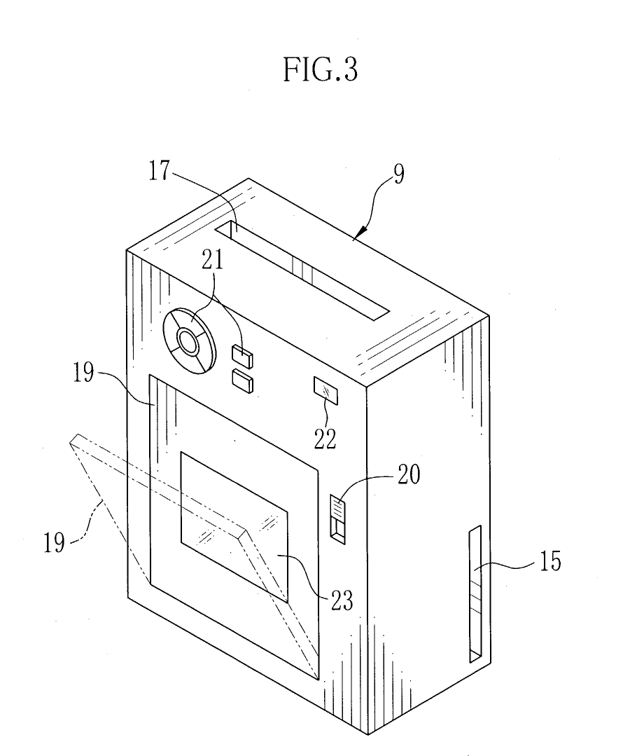

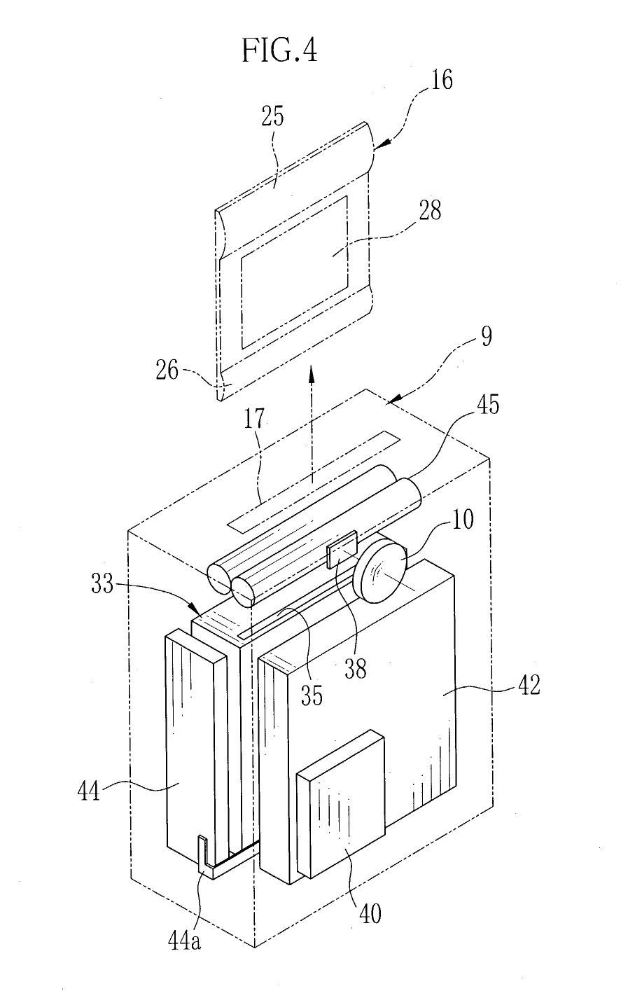

As shown in FIG. 3, the back of the digital camera 9 has an opening lid 19 which opens or closes a pack chamber for loading a film pack, an operation member 20 for opening the opening lid 19, plural operation buttons 21 which are used for setting and operating the digital camera 9, and an eyepiece finder window 22. On the opening lid 19, a liquid crystal display panel (LCD) 23 is provided, and used for as a view finder, for various settings, or reproduction of the image stored in the memory card 14.

As the recording material for the mini photo print 16, a mono-sheet type instant film unit is used. The size of the instant film unit is 38×41.5 mm, and the picture frame size thereof is 27×20 mm. In the instant film unit, a photosensitive sheet and a transparent cover sheet are superposed each other. On the inner surface of the photosensitive sheet, a latent image is formed by exposure, and on the outer surface of the photosensitive sheet, the latent image is transferred as a positive image through developer. In end portions of the instant film unit, a pod 25 and a trap 26 are provided. In the pod 25 and the trap 26, there are respectively contained a developer for developing and absorb material for absorbing the excess developer which is remained after spread.

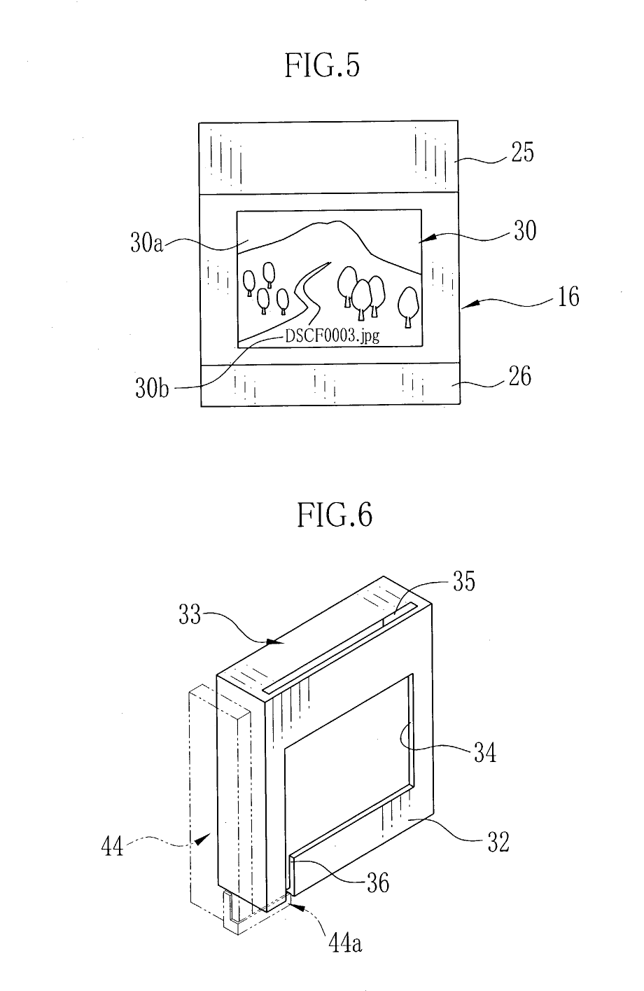

In the mini photo print 16, after a first surface (an outer surface of the cover sheet) 28 is exposed, the pod 25 is ruptured by a pair of spreading rollers, and then the developer is spread between the both sheets. After the predetermined developing/fixing time is passed, as shown in FIG. 5, a positive image is appeared on a second surface (the outer surface of the photosensitive sheet) 30, which is provided on the opposite side of the first surface 28.

The plural mini photo prints 16 are contained in the case 32 having an almost box shape as shown in FIG. 6, and this package is placed on the market as a film pack 33. The case 32 is formed by paper resin which is mixed material made of paper and plastic. The paper resin can be burned as well as paper so that it is good for the environment.

The front of the case 32 has an exposure aperture 34 for exposing the first surface 28 of the mini photo print 16, and the top surface of the case 32 has a mouth 35 through which the mini photo print 16 is delivered from the case 32. In the below end of the exposure aperture 34, the notch 36 in which a well-known claw member 44a is inserted is formed. The exposed mini photo print 16 is delivered from the case 32 by the claw member 44a, and the end of the mini photo print 16 is inserted between the spreading rollers.

In the unused film pack 33, the exposure aperture 34 is covered by a light-shield sheet. If the film pack 33 is loaded in the pack chamber, the light-shield sheet is automatically discharged.

Behind the taking lens 10, an imaging device 38, such as a CCD image sensor or a CMOS sensor, is disposed. The taking lens 10 forms the image of a subject on a light-receiving surface of the imaging device 38. The imaging device 38 photoelectrically converts the image formed on the light-receiving surface, and then an electronic signal is outputted. The electronic signal is converted to an image data by a digital converter.

The image data is processed by an image processing circuit, and then written in the memory card 14 by a reader/writer 40 which is disposed in the back of the card slot 15. When the image data is stored in the memory card 14, a file name is given thereto as the identity information. The file name represents numbers from DSCF0001.JPG to DSCF000n.JPG numbered in order of taking.

In front of the film pack 33 loaded in the pack chamber, a print unit 42 is disposed. The print unit 42 is constituted of a print head provided with LED of three colors: R, G and B, and a moving mechanism for moving the print head, and the print unit 42 exposes the first surface 28 of the mini photo print 16 in accordance with the print data thereof.

It is to be noted that a frame-exposure type print unit may be used. This print unit has a small-sized LCD which is disposed oppositely to the film pack 33. An image displayed on the small-sized CCD is projected on the mini photo print 16.

A claw mechanism 44 is disposed at the side of the film pack 33. Above the film pack 33, a pair of spreading rollers 45 is provided to spread the developer in the mini photo print 16.

As shown in FIG. 5, a file name 30b is printed on the mini photo print 16 with an image 30a. Thereby, the content of the image and the file name thereof are easy to be associated with each other.

In the digital camera 9, the image stored in the memory card 14 can be printed arbitrary, or a print having originality can be made by combination of the image data and template data which is stored beforehand. Additionally, the user 2 has a choice between imprinting and not imprinting the file name 30b by operating the operation buttons 21. When the user 2 selects not to imprint the file name 30b, since the file name 30b is not imprinted on the mini photo print 16, the file name 30b never conceal the image or the template image.

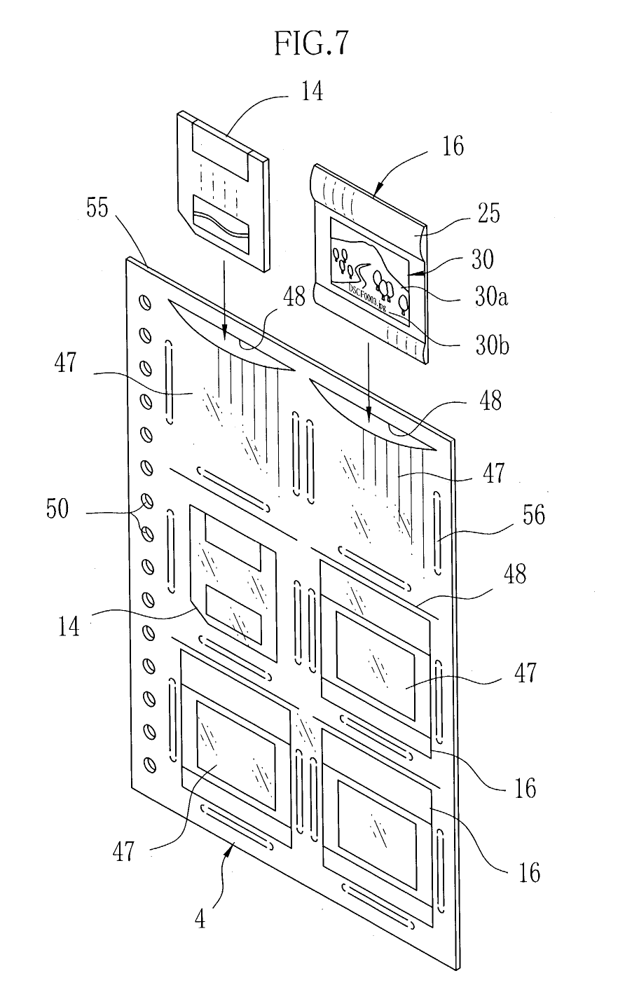

As shown in FIG. 7, the print holder 4 is a sheet-like shape, and front and rear surfaces thereof respectively have six pockets 47 for containing the mini photo prints 16. The print holder 4 is constituted of a board (a support sheet) 55 and two transparent plastic sheets. Plural notch 48 is formed on the transparent plastic sheet in order to insert the memory card 14 or the mini photo print 16 into the pocket 47. Each of the transparent plastic sheet is adhered to the board 55 at portions 56 in order to form the pocket 47.

As the mini photo print 16 is contained in the print holder 4, the taken image 30a and the file name 30b can be identified from outside through the transparent plastic sheet. Accordingly, when the image is printed by the personal printer 5, or the user 2 requests to print the image in the laboratory 6, the print holder 4 can be used as an index.

The memory card 14 is slightly smaller than the mini photo print 16, so that the memory card 14 also can be contained in the pocket 47. Thereby, the memory card 14 can be arranged so as to identify the content of the image data therein immediately.

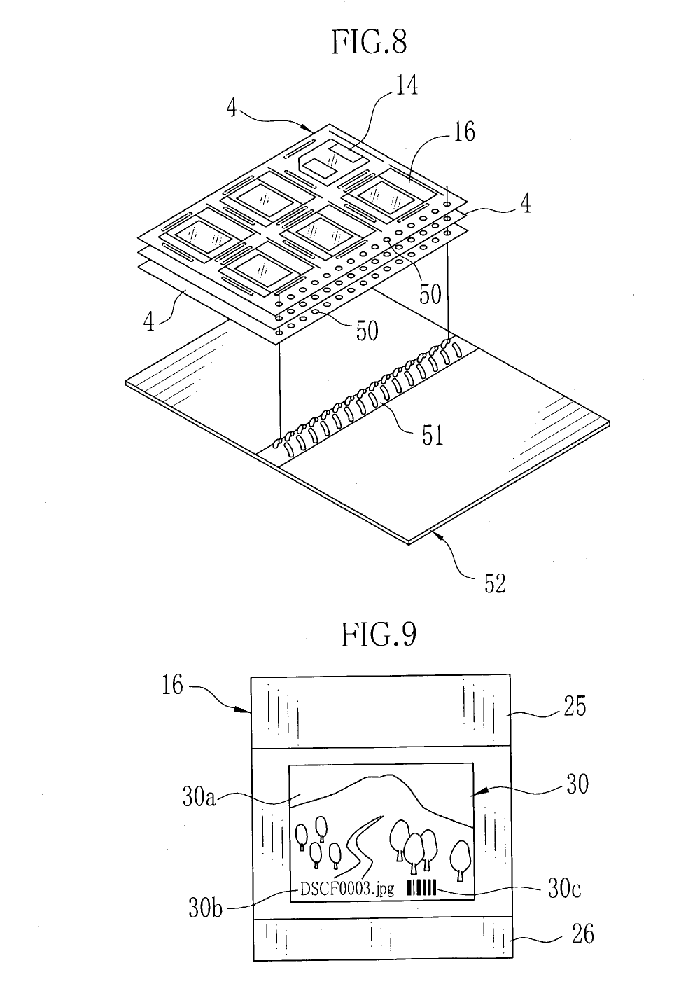

Additionally, in the side edge of the print holder 4, there are plural holes 50 for filing the print holder 4. As shown in FIG. 8, at least one of the print holders 4 is put in a file 52 which has a file fitting 51, so that the file 52 can be used as an album with an index function.

Next, the operation of the above embodiment is explained. When the shutter button 13 is pushed, the image of the subject is converted photoelectrically by the imaging device 38. An electronic signal outputted from the imaging device 38 is converted to the image data by an A/D converter. The image data is stored in the memory card 14 by a reader/writer 40. Herewith, one of the serial file names from DSCF0001.JPG to DSCF000n.JPG is given to the image data. In the memory card 14, the file is made for every image. The file is divided into a tag area and an image data area, and the file name 30b is stored in the tag area.

The digital camera 9 makes the mini photo print 16 on which the taken image 30a and the file name 30b are printed. In the process of making the mini photo print 16, the image data and file name data read from the memory card 14 are converted to the print data after composed each other. The print data is fed to a print unit 42. In the print unit 42, a moving mechanism is moved so as to scan the mini photo print 16, the LED of R, G and B of the print head being emitted, so that scanning exposure is carried out on the first surface 28 of the mini photo print 16.

After the exposure is completed, the claw mechanism 44 is operated, so that the mini photo print 16 is pushed out from the film pack 33. While the mini photo print 16 is drawn by the pair of spreading rollers 45, the developer pod is ruptured, and then the developer is spread uniformly. After the predetermined time has passed, the image 30a and the file name 30b are appeared on the second surface 30 of the mini photo print 16.

Though the mini photo print 16 is automatically made every taking, the mini photo print 16 may be made by means of designating the image as observing the liquid crystal display (LCD) 23. The auto mode and manual mode for making the mini photo print 16 can be selected by operating the operation buttons 21.

The mini photo print 16 is contained in the transparent pocket 47 in the print holder 4. When the image is printed in the home, the personal printer 5 is used. In this case, after the memory card 14 is set in the personal printer 5, the user 2 can designate the file name 30b of the image to be printed, looking at the print holder 4.

Thereby, it is not necessary to confirm the image by LCD 23 of the digital camera 9 to confirm the image by a television or a computer connected to the digital camera, or to remember or write down the file name 30b, so that it is possible to print the image easily.

Additionally, if the user 2 requests the laboratory 6 to print the image 30a, the user 2 brings the print holder 4 or the file 52 which contains at least one of the print holders 4 to the laboratory 6, and designates the file name 30b of the image to be printed, referring to the print holder 4. In this case, as well as the above mentioned, since the file name 30b can be found by the mini photo print 16 immediately, the user 2 can request to print easily without any mistake.

In the above case, since the memory card 14 is contained in the pocket 47 of the print holder 4, the user 2 does not forget the memory card 14 or bring another memory card of image that does not need to be printed.

In the above embodiment, although the file name 30b is printed in a capital letter on the mini photo print 16, as shown in FIG. 9, both a bar code 30c which represents the file name 30b and the file name 30b can be printed thereon. In this case, a bar-code reader for reading the bar code 30c is provided in the laboratory 6. The file name 30b can be inputted with just reading the bar code 13c on the mini photo print 16 by the bar-code reader.

In addition, if the mini photo print 16 is made every photographing, the LCD 23 for confirming the taken image 30a can be omitted. Thereby, the digital camera 9 can be miniaturized; besides, it is possible to lower the cost and reduce electric power to be consumed.

Moreover, it is possible to use the print holder 4 as a print order form in the laboratory 6 by providing an order area for writing print order information. In this case, the user can request to print the taken image 30a by just handing in the print holder 4 to the laboratory 6.

It is to be understood that the above-described embodiments are simply of the invention. Other embodiments may be devised by those skilled in the art which will embody the principal of the invention and fall within the sprit and scope thereof.

What is claimed is:

1. A print system comprising;
a digital camera includes an imaging device for converting an image of a subject to an image data, a writing section for writing said image data and an identity information data given thereto in memory media, and a print section for making an image confirmation print that said image and said identity information is printed on recording material, in accordance with said image data and said identity information data read from said memory media;
a print holder for containing said image confirmation print with arranged in a plane; and
a printer for printing said image based on said image data in said memory media, said image data being specified by said identity information which is designated as referring said image confirmation print in said print holder.

2. The print system as claimed in claim 1, wherein said identity information is a file name given to said image.

3. The print system as claimed in claim 2, wherein said digital camera further includes a means for selecting whether said identity information is imprinted on said image confirmation print or not.

4. The print system as claimed in claim 3, wherein said memory media is a memory card, said memory card being contained in said print holder with plurality of said image confirmation print.

5. The print system as claimed in claim 4, wherein said recording material is an instant film unit.

6. A print method comprising the steps of:
taking a subject by use of a digital camera, an image data of said subject being written in memory media with an identity information data;
making an image confirmation print having a taken image and an identity information which are printed on said recording material by a print section of said digital camera, in accordance with said image data and said identity information read from said memory media;
inputting said identity information of said image to be printed as referring said image confirmation print; and
printing said image based on said image data in said memory media, said image data being specified by said identity information which is designated as referring said image confirmation print in a print holder.

7. The print method as claimed in claim 6, further comprising the step of:
containing said image confirmation print in a print holder with arranged in a plane.

8. The print method as claimed in claim 7, wherein said recording material is an instant film unit.

9. A digital camera comprising:
an imaging device for converting an image of a subject to an image data;
a writing section for writing said image data and an identity information data given thereto in memory media; and
a print section for making an image confirmation print having said image and said identity information, in accordance with said image data and said identity information read from said memory media.

10. The digital camera as claimed in claim 9, wherein said identity information is a file name given to said image.

11. The digital camera as claimed in claim 10, further comprising a means for selecting whether said identity information is imprinted on said image confirmation print or not.

12. The digital camera as claimed in claim 11, wherein said print section further imprints a bar code for representing said file name on said image confirmation print.

13. The digital camera as claimed in claim 12, wherein said image confirmation print is made of an instant film unit.
